(19) United States
(12) Patent Application Publication
(10) Pub. No.: US 2004/0222744 A1
(43) Pub. Date: Nov. 11, 2004

(54) Vacuum tube electrode structure

(75) Inventors: Robert Tornoe, Sunol, CA (US); Yanxia Li, Pleasanton, CA (US); Paul A. Krzeminski, San Mateo, CA (US); Edmund T. Davies, Orinda, CA (US); Leroy L. Higgins, Newark, CA (US); Gordon R. Lavering, Belmont, CA (US)

Correspondence Address: David B. Ritchie, Thelen Reid & Priest LLP, P.O. Box 640640, San Jose, CA, 95164-0640, US

(73) Assignee: Communications & Power Industries, Inc.,

(21) Appl. No.: 10/718,258

(22) Filed: Nov. 19, 2003

Related U.S. Application Data
(60) Provisional application No. 60/428,390, filed on Nov. 21, 2002.

(51) Int. Cl. H01J 25/34

(52) U.S. Cl. 315/3.5

(57) ABSTRACT

An electrode structure for a vacuum tube is formed by having a ceramic insulating body act as the tube wall. Electrode areas are formed on the inside of the tube by coating the inside of the tube wall with a conductor. These electrode areas are then coupled, as necessary, to external electronic circuits. The coupling may be performed by through-wall connections, metallized abutting connections and other conventional means. The ceramic insulating body may be generally cylindrical in shape and may be formed of a material such as aluminum nitride, beryllium oxide, aluminum oxide and the like.

### STATEMENT OF RELATED APPLICATION

The present application claims priority based upon U.S. Provisional Patent Application Ser. No. 60/428,390, filed on Nov. 21, 2002 in the name of inventors Robert N. Tornoe, Yanxia Li, Paul A. Krzeminski, Edmund T. Davies, Leroy L. Higgins and Gordon R. Layering, and entitled, “Vacuum Tube Electrode Structure”, commonly owned herewith.

### FIELD OF THE INVENTION

The present invention relates to the field of vacuum and electron tubes and similar structures which employ an electrode on the inside of the tube to communicate an electric signal with the outside of the tube.

### BACKGROUND OF THE INVENTION

Electron vacuum tubes are used for a wide variety of purposes. One class of such tubes are linear beam electron tubes. These include inductive output tubes (IOTs or Klystrodes®), klystrons and the like. IOTs are typically used as radio frequency (RF) amplifiers in the 470 MHz to 860 MHz ultra-high frequency (UHF) band, in broadcast television transmitters, science, and in industrial markets.

Certain IOTs employ a single stage collector held at a single voltage (typically ground) to collect spent electrons. The electrical efficiency of such IOTs may be improved by replacing the single stage collector with a multi-stage depressed collector (MSDC). MSDC designs typically employ two or more collectors held at different respective potentials with one stage typically serving as a depressed collector stage. An IOT's electrical efficiency may be improved from the neighborhood of about 34% for a single stage collector to about 60% with the addition of an MSDC collector under certain operating conditions. Since the individual collectors in a MSDC design operate at different potentials, they are required to be electrically and thermally isolated. Oil or deionized water are typically used as a cooling fluid to keep collectors electrically isolated from one another while still providing conductive fluid cooling.

### BRIEF DESCRIPTION OF THE INVENTION

A multi-electrode collector structure is formed using a single ceramic insulating cylinder body, which also serves as the vacuum tube envelope. These electrodes or collector stages are formed on the inside of the insulating cylinder by use of a conductive coating material spaced apart to separate the stages. These electrode areas are then coupled, as necessary, to external electronic circuits. The coupling may be performed by through-wall connections, metallized abutting connections and other conventional means. The ceramic insulating body may be generally cylindrical in shape and may be formed of a high-temperature electrically insulating material such as the ceramic materials aluminum nitride, berillium oxide and aluminum oxide, and the like. The heat generated from the power dissipated on the inside diameter at the different stages of the insulator cylinder is conducted through the ceramic to a cooling media such as normal municipal water.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a cross sectional diagram of an electron tube in accordance with one embodiment of the present invention.

FIG. 2 is a cross sectional diagram of an electron tube in accordance with another embodiment of the present invention.

FIG. 3 is a cross sectional diagram of a portion of the electron tube of FIG. 2 shown in more detail in accordance with one embodiment of the present invention.

FIG. 4 is a cross sectional diagram of a portion of an electron tube in accordance with an embodiment of the present invention which may, for example, be a cylindrical tetrode or triode.

### DETAILED DESCRIPTION

Embodiments of the present invention are described herein in the context of a electron tube. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

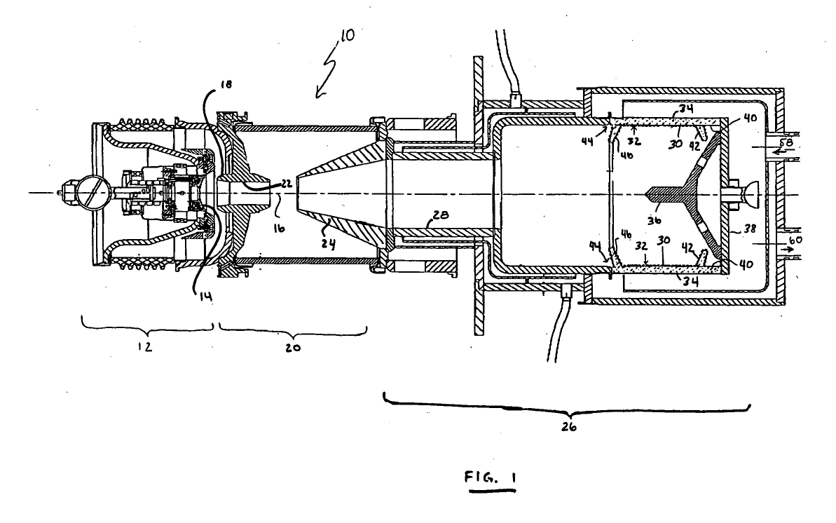

Turning now to FIG. 1 an electron tube 10 is shown which, in accordance with an embodiment of the present invention, is an IOT or Klystrode® which may be used for amplifying a UHF signal for broadcast purposes. Electron tube 10 includes, generally, an electron gun portion 12 including a cathode 14 for generating an electron beam traveling along axis 16, an anode 18, an RF interaction section 20, drift tube section 22, and a tail pipe 24, all in accordance with the prior art, and a multi-stage depressed collector (MSDC) section 26 in accordance with the present invention.

MSDC 26 includes a first electrode 28 held at a ground potential. MSDC 26 includes a second electrode 30, typically held at a potential depressed relative to ground potential. Second electrode 30 is formed from a metallization layer 32 disposed to coat a portion of the inside of ceramic tube 34 which forms a portion of the vacuum envelope of tube 10. MSDC 26 also includes a third electrode 36 which may be fabricated from a conductive material such as oxygen free copper and brazed to end piece 38 in a conventional manner. Third electrode 36 may be held at a desired potential such as cathode or a voltage depressed relative to ground. Third electrode 36 is electrically insulated from second electrode 30 by means of insulating (non-coated) portion 40 of ceramic tube 34. Insulating portion 40 is protected from becoming conductive by means of sputtered material by shield 42 which may be formed of a conductive coated ceramic or metal material. Similarly, first electrode 28 and second electrode 30 are electrically insulated from one another by means of an uncoated portion 44 of ceramic tube 34. Shield 46 thus prevents uncoated portion 44 from becoming conductive and being bombarded by electrons.

Metallization layer 32 may be formed by plating, coating or sputtering a conductive material onto the inside surface of the tube. Such processes include painting or plating a conductive material such as copper or another conducting metal, using the well-known molybdenum-manganese process or another process well known to those of ordinary skill in the art.

Shields 42 and 46 may be formed of conductive material, coated ceramic or fabricated of a conductive metal material such as copper. Alternatively, they may be formed into the ceramic tube 34 or brazed or otherwise held fixedly in place. They may also be simply rings placed in position and held in place by other components within tube 10. The purpose of shields 42 and 46 is to prevent the formation of a conductive path between the various electrodes thereby shorting them together.

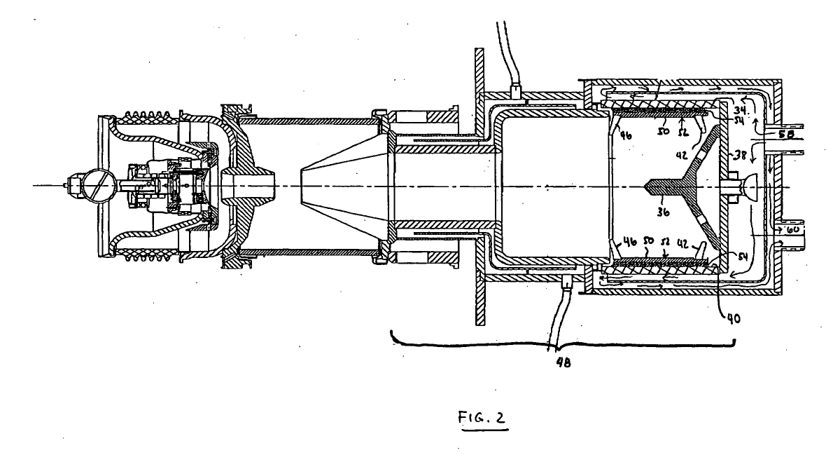

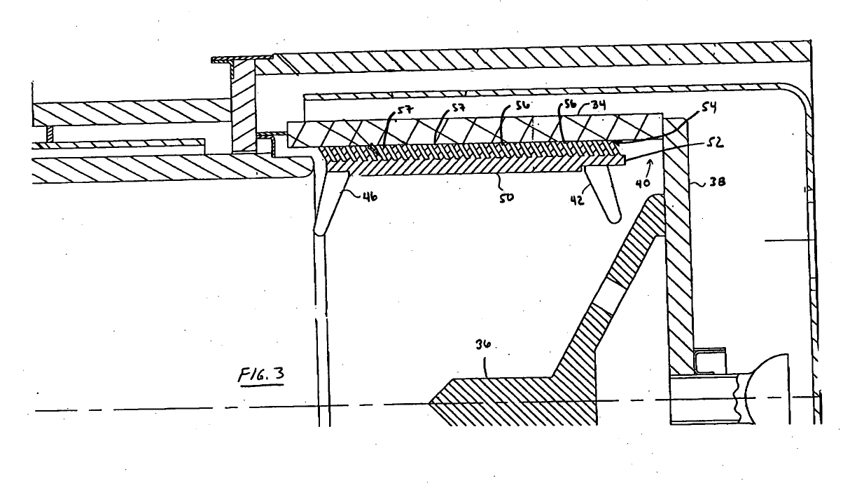

Turning now to FIGS. 2 and 3, an alternative embodiment of the present invention is illustrated. In this embodiment, MSDC 48 includes a second electrode 50 and a third electrode 36. The difference here between second electrode 30 of FIG. 1 and second electrode 50 is that in the case of second electrode 50 a cylinder of copper 52 is inserted into tube 34 and held in place by a brazing material 54. Stress relief may be provided to relieve hoop stress due to the copper cooling and contracting faster than the ceramic tube (which might tend to crack the ceramic tube 34 over repeated thermal cyclings) by slotting the copper cylinder 52 with slots 56 as shown so that it comprises a plurality of circularly disposed fingers 57 and slots 56, said fingers being affixed at a distal end thereof to brazing material 54 and/or metallization layer 30.

In the embodiment illustrated in FIGS. 2 and 3, the shield portions 42 and 46 are implemented in essentially the same way as in the FIG. 1 embodiment.

Liquid cooling is provided to the MSDC by providing a cooling fluid to one of cooling ports 58, 60 and removing it from the other of the ports. For example, if cooling fluid is provided to port 58 and removed from port 60, the fluid will move as shown generally by the arrows in the FIG. 2 drawing. Standard cooling fluid such as city water or a 50/50 solution of Ethylene Glycol and water and the like may be used to provide fluid cooling without the need to provide high voltage isolation between MSDC stages as with cooling oils or specially treated water with long hoses.

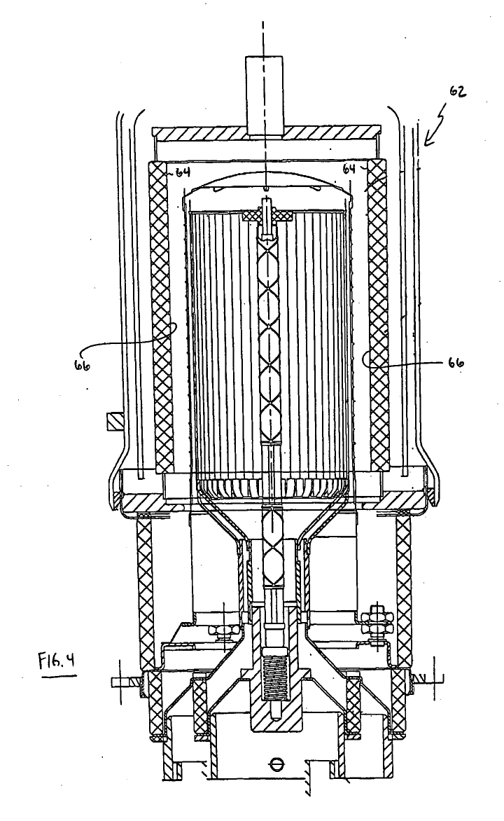

Turning now to FIG. 4, an embodiment of the present invention is utilized in an electron tube 62 other than a linear beam electron tube. The tube may be, for example, a triode or tetrode or similar type of vacuum tube device. In this embodiment, an insulating member 64 surrounds a portion of the tube 62. Member 64 may be a ceramic cylindrical tube and may form a portion of the vacuum wall of the device 62. The inside surface 66, of member 64 is coated with a metallization layer or a metal portion as described above. The metallization may be in the form of a layer, a tube or in the form of a metal structure with a stress relief structure as in the FIG. 3 embodiment. In this embodiment, surface 66 may be an electrode for passing signals into and/or out of the area of device 62 contained by member 64. It may also serve as an electronic shield to prevent signal leakage as in a Faraday shield.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. An electron tube, comprising:
an electrically insulating wall portion;
an electrode formed on an inside portion of said insulating wall portion, the electrode comprising a metallization layer formed on said inside portion of said insulating wall portion; and
an electrical path coupling said electrode to a terminal on an exterior of the tube.

2. An electron tube, comprising:
an electrically insulating wall portion;
an electrode formed on an inside portion of said insulating wall portion, the electrode comprising a metallization layer formed on said inside portion of said insulating wall portion and a cylindrical copper member including a plurality of circularly disposed fingers and slots, said fingers affixed at a distal end thereof to said metallization layer; and
an electrical path coupling said electrode to a terminal on an exterior of the tube.

3. An electron tube in accordance with claim 1, wherein said electrically insulating wall portion comprises a ceramic material.

4. An electron tube in accordance with claim 2, wherein said electrically insulating wall portion comprises a ceramic material.

5. An electron tube in accordance with claim 3 wherein said tube further comprises a fluid cooling apparatus in thermal contact with an exterior of said tube.

6. An electron tube in accordance with claim 4 wherein said tube further comprises a fluid cooling apparatus in thermal contact with an exterior of said tube.

7. An electron tube in accordance with claim 5 wherein said ceramic comprises a material selected from the group consisting of: aluminum oxide, beryllium oxide and aluminum nitride.

8. An electron tube in accordance with claim 6 wherein said tube further comprises a fluid cooling apparatus in thermal contact with an exterior of said tube.

9. An electron tube, comprising:
a linear beam electron tube, comprising:
vacuum envelope means for maintaining a vacuum in the tube, said vacuum envelope means including an electrically insulating wall portion;
means for conducting electricity disposed on an inside of said insulating wall portion; and
terminal means disposed on an outside of said insulating wall portion and electrically coupled to said means for conducting electricity.

10. The electron tube of claim 9, wherein said means for conducting electricity comprises a layer of metallization.

11. The electron tube of claim 9, wherein said means for conducting electricity comprises a cylindrical copper member having a plurality of circularly disposed fingers and slots.

12. The electron tube of claim 11, wherein distal ends of said fingers are brazed to said insulating wall portion.

13. The electron tube of claim 10, wherein said means for conducting electricity comprises a cylindrical copper member having a plurality of circularly disposed fingers and slots and wherein distal ends of said fingers are brazed to said layer of metallization.

14. The apparatus of claim 12, wherein said vacuum envelope means comprises a ceramic material.

15. The apparatus of claim 13, wherein said vacuum envelope means comprises a ceramic material.
